(19) United States
(12) Patent Application Publication
(10) Pub. No.: US 2008/0029258 A1
(43) Pub. Date: Feb. 7, 2008

(54) Method for Producing a Heat Exchanger

(76) Inventors: Michael Kranich, Besigheim (DE); Klaus Kuebler, Oberrot (DE); Karl-Heinz Staffa, Stuttgart (DE); Christoph Walter, Stuttgart (DE)

Correspondence Address: FOLEY AND LARDNER LLP;SUITE 500, 3000 K STREET NW, WASHINGTON, DC, 20007, US

(21) Appl. No.: 11/664,606

(22) PCT Filed: Oct. 5, 2005
(86) PCT No.: PCT/EP05/10693

§ 371 Date: May 3, 2007

(30) Foreign Application Priority Data
Oct. 5, 2004 (DE) 10 2004 048 767.7

(51) Int. Cl. B23K 1/20; B21D 53/02; B23K 31/02; F28F 1/10

(52) U.S. Cl. 165/177; 228/183; 29/890.03

(57) ABSTRACT

The invention relates to a method for producing a heat exchanger (1), in particular for a motor vehicle. The invention is characterised in that a sub-assembly consisting or the two connection pipes (4) that supply or evacuate the coolant and at least the upper panel (3) or surface of the heat exchanger (1), which contains the openings associated with the connection pipes (4), are positioned, mechanically pre-assembled and then, together with the remaining heat exchanger (1) parts to be soldered, are soldered in a common work operation. The invention also relates to a heat exchanger (1) that is produced according to said method.

The invention relates to a method for producing a heat exchanger, in particular for ventilation, heating or air conditioning systems in a motor vehicle, which can be operated with high internal pressures, as per the preamble of claim 1.

DE 102 60 107 A1 discloses a heat exchanger for an air conditioning .system of a motor vehicle in which R134a or R744 can be used as refrigerant, with the individual components being fixedly connected to one another in a cohesive, force-fitting and/or form-fitting manner in such a way that the interior space of the components is gas-tight and/or liquid-tight in relation to the surroundings of the heat exchanger even at high pressures of up to approximately 300 bar.

A heat exchanger is usually produced by means of the individual parts, that is to say in particular the collector, flat tubes and interposed corrugated fins, being placed together and soldered. The connecting tubes which are to be connected to the collector and through which the refrigerant can be supplied or discharged are conventionally positioned and fastened, for example by means of soldering, welding or for example by means of Lokrings, only after the soldering of the heat exchanger has been completed. This is difficult in particular in the case of heat exchangers of small installation depths, that is to say of 40 mm and less, and the associated restricted spatial conditions. In addition, the heat exchanger surface can be adversely affected.

Proceeding from said prior art, it is an object of the invention to provide a heat exchanger which is improved with regard in particular to the production process. Said object is achieved by means of a method for producing a heat exchanger having the features of claim 1. Advantageous embodiments are the subject matter of the subclaims.

According to the invention, in order to produce a heat exchanger, in particular for a motor vehicle, a modular unit composed of the two connecting tubes, which supply or discharge the refrigerant, and at least the uppermost plate, in which the openings pertaining to the connecting tubes are provided, with at least one opening being provided per connecting tube of the heat exchanger, is positioned and mechanically pre-assembled, and after being placed together, is soldered in a single common working process to the other parts of the heat exchanger which are to be soldered. Here, the heat exchanger tubes, in particular flat tubes, and corrugated fins are stacked in the conventional way before soldering, are attached to the positioned and pre-fixed modular unit, and are all soldered in one working process, so that the previously conventional additional working processes for retrospectively soldering the connecting tubes onto the collector etc. are dispensed with. The term “plate” is to be interpreted broadly and should also encompass equivalent embodiments in which the collector is not necessarily formed by planar plates, so that said collector can by all means be formed substantially in one part and by a hollow profile.

The heat exchanger is preferably designed for operating pressures of 90 bar, though preferably at least for 50 bar, so that R744, that is to say CO₂, can be used as refrigerant.

During pre-assembly, the connecting tubes are preferably positioned and pre-assembled at least on the outermost plate by means of one or more brackets. Said bracket connection for providing pre-fixing is particularly suitable for heat exchangers of small installation depth; since the forces acting on the brackets here are relatively low compared to the forces acting on the brackets in the case of heat exchangers of large installation depth. The brackets preferably engage behind all of the plates which form the collector.

The connecting tubes are alternatively or additionally attached during pre-assembly by means of pins. Here, said pins are inserted into openings provided in the one or more plates and into openings provided in the connecting tubes. Here, the pins are preferably solder-plated, so that the pins are soldered into the openings during the soldering process, resulting in the gaps between the pins and the inner lateral surfaces of the openings being sealed off, so that no leakage is possible.

The connecting tubes are alternatively or additionally attached during pre-assembly to outwardly projecting rim holes on which openings of the connecting tubes are placed. Here, the self-locking action is sufficient for a sufficiently secure connection. The rim holes preferably remain open and serve for supplying or discharging refrigerant. Here, at least one rim hole is provided per connecting tube; two or more rim holes are preferably provided per connecting tube.

The connecting tubes are alternatively or additionally pre-fixed during pre-assembly by means of solder points between the connecting tubes and the outermost plate. Said solder points can be soldered connections which have a considerably lower melting temperature than the final soldered connections. The solder points for the pre-fixing are preferably formed so as to be spatially delimited.

The connecting tubes are alternatively or additionally pre-fixed during pre-assembly by means of at least one side part which projects beyond the connecting tubes and in which one leadthrough per connecting tube is formed, with the corresponding connecting tube being inserted through said leadthrough and being pre-fixed by means thereof.

In order to provide pre-fixing, it is additionally or alternatively possible for the outermost plate to have projecting lugs to which the connecting tubes are pre-fixed, in particular by means of stapling.

Before pre-assembly, at least the outermost plate is solder-plated in the region of contact of the connecting tubes, or the connecting tubes are solder-plated in the region of contact against the outermost plate, as a result of which additional working processes can be dispensed with.

The invention is explained in detail in the following on the basis of exemplary embodiments and with reference to the drawing, in which:

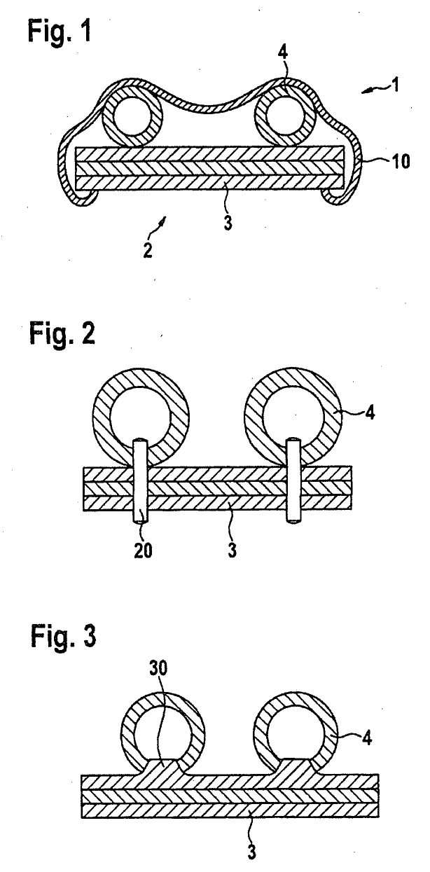

FIG. 1 shows a schematically illustrated section through the upper region of a heat exchanger as per the first exemplary embodiment,

FIG. 2 shows a schematically illustrated section through the upper region of a heat exchanger as per the second exemplary embodiment,

FIG. 3 shows a schematically illustrated section through the upper region of a heat exchanger as per the third exemplary embodiment,

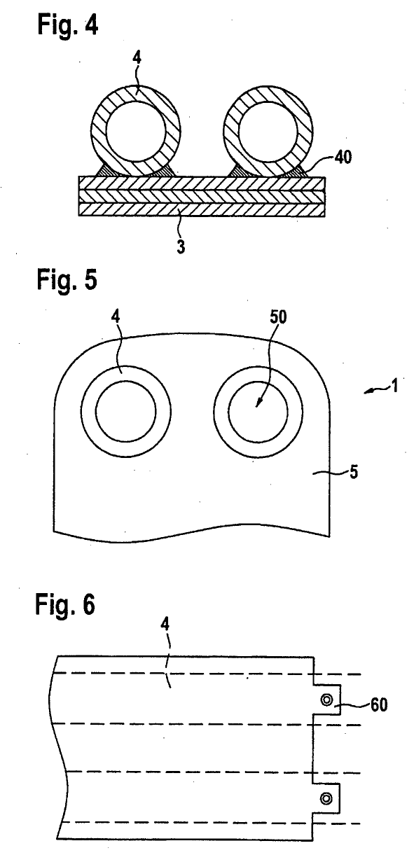

FIG. 4 shows a schematically illustrated section through the upper region of a heat exchanger as per the fourth exemplary embodiment,

FIG. 5 shows a schematically illustrated section through the upper region of a heat exchanger as per the fifth exemplary embodiment,

FIG. 6 shows a schematic plan view of the uppermost plate without connecting tubes, as per the sixth exemplary embodiment,

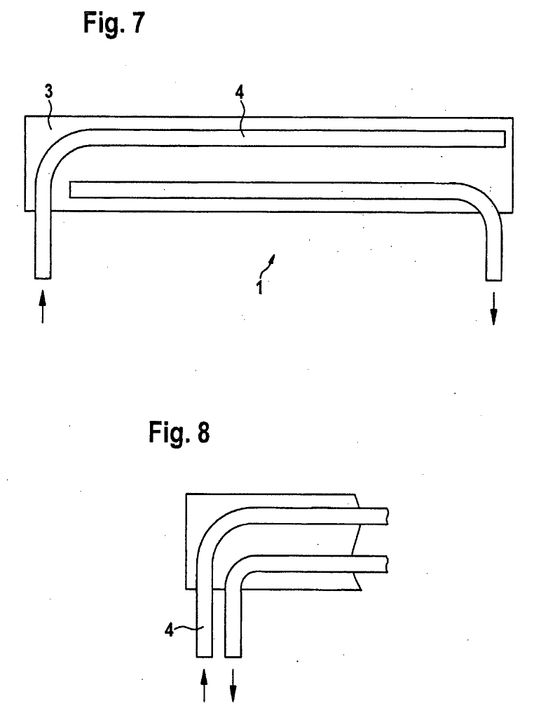

FIG. 7 shows a schematic plan view for clarifying a first embodiment with regard to the tube arrangement on the heat exchanger, and

FIG. 8 shows a schematic, partially illustrated plan view for clarifying a second embodiment with regard to the connecting tube arrangement on the heat exchanger.

The following text explicitly incorporates the disclosure content of DE 102 60 107 A1, in particular with regard to the general design of a heat exchanger, with regard to the usable materials, described herein, such as for example aluminum, aluminum alloys, with regard to the applicable refrigerant, such as for example carbon dioxide, R 134a, nitrogen, oxygen, air, hydrocarbons, and with regard to the described dimensions of the heat exchanger.

A heat exchanger 1, which is designed for operating pressures of 60 bar, of a motor vehicle air conditioning system (not illustrated in any more detail) is formed by a plurality of plates 3, which form a collector 2 and in the present case are flat tubes (not illustrated) which are curved into a U-shape and are arranged in a known way between the different chambers of the collector 2, and corrugated fins (not illustrated) which are arranged between the flat tubes. Here, the embodiment described immediately above is identical to the six exemplary embodiments described below. In the present case, in order to protect the outermost corrugated fins, plate-shaped side parts 5 are arranged laterally, that is to say in the view direction of FIGS. 7 and 8 which show two different embodiments of the connecting tubes 4, specifically one with a parallel flow direction (FIG. 7) and one with an opposing flow direction (FIG. 8) of the refrigerant (indicated by arrows), which side parts 5 are of relevance for the connecting-tube-side region of the heat exchanger 1 only in the case of the fifth exemplary embodiment which is described at a later stage with reference to FIG. 5. In the other exemplary embodiments, the side parts extend only at most up to the end of the collector 2, and are therefore not visible in the detail illustrated in FIGS. 1 to 5.

According to the first exemplary embodiment illustrated in FIG. 1, the two connecting tubes 4 are positioned on and pre-fixed to the plates 3, which form the collector 2, by means of a plurality of brackets 10, thereby forming a modular unit composed of the connecting tubes 4 and the plates 3. Said modular unit, together with the bracket 10, is positioned on and pre-fixed to the other parts of the heat exchanger, that is to say in particular to the flat tubes and corrugated fins, during assembly of said heat exchanger. The parts of the modular unit are subsequently soldered to one another and to the other parts of the heat exchanger 1 in one working process.

As illustrated in FIG. 1, the bracket 10 has a design which is matched to the intended position of the connecting tubes 4. The bracket 10 additionally engages behind the lowest of the plates 3 which form the collector 2, and clamps the two connecting tubes 4, which are automatically aligned in the U-shaped depressions, relative to the outermost of the plates 3 which form the collector 2, so that said plates 3, in connection with the design of the bracket 10, too, cannot be displaced.

In the present case, both the connecting tubes 4 and the plates 3 are solder-plated, so that the solder melts in the soldering furnace and said parts, as well as the other parts of the heat exchanger 1, are fixedly connected to one another in one single working process, and a relatively large-area connection between the connecting tubes 4 and the outermost plate 3 is ensured.

According to the second exemplary embodiment illustrated in FIG. 2, five pins 20 are provided per connecting tube 4, which pins are inserted into bores which are provided in the plates 3 and in the connecting tubes 4. Said pin connections permit precise positioning of the connecting tubes 4 on the outermost plate 3. The pin connection additionally permits, on account of the length illustrated in FIG. 2, positioning of the individual plates 3. The given fit between the pin 20 and the bores also serves to provide sufficient pre-fixing of the connecting tubes 4 to the outermost plate 3 and of the plates 3 to one another, so that no additional measures are necessary for securing the modular unit. It is however possible in principle to provide an additional securing measure by means of brackets as described above, with it being possible for said securing measure to be purely a transport securing measure, that is to say the brackets are removed again before soldering, or an additional securing measure which can also if appropriate be soldered too.

The pins 20 of the pin connections remain in the heat exchanger. In the present case, the pins 20, like the connecting tubes 4 and the plates 3, are solder-plated, so that no additional measures are necessary for soldering within the modular unit.

In the third exemplary embodiment illustrated in FIG. 3, five outwardly projecting rim holes 30 per connecting tube 4 are formed in the outermost plate 3, with radial openings which are formed on the connecting tubes 4 being placed onto said rim holes 30. Here, the rim holes 30 and the openings in the connecting tubes 4 serve, in the fully-assembled and soldered state, as the inlets and outlets of the collector 2 which is formed by the plates 3. For pre-assembly, in the present case, the self-locking of the rim holes 30 in the openings is sufficient to ensure a sufficient degree of pre-fixing of the connecting tubes 4 to the outermost plate 3, so that additional securing measures for holding the modular unit together can be dispensed with, which however does not exclude the possibility of additional securing measures such as for example brackets. According to the present exemplary embodiment, the outermost plate 3 is solder-plated, wherein in the present case, the solder plating takes place before the rim holes 30 are produced. It is of course also possible for a solder-plating process to take place after the production of the rim holes 30. It is also possible if appropriate for only the openings to be solder-plated, or for the openings to also be solder-plated, in order to ensure secure fixing of the connecting tubes 4 to the outermost plate 3 after passing through the soldering furnace.

A combination, for example, of pin connections and the rim-hole/opening connections is of course also possible, so that the pin connections are arranged in regions in which no collector opening for introducing or discharging refrigerant is provided, and the fastening takes place by means of the rim-hole/opening connections in the other regions in which introduction or discharge points are to be provided.

The end of the connecting tubes 4, if not inserted into the collector 2 by bending the connecting tube 4 and inserting the end into the collector 2, is closed off by means of a punched, solder-plated circular blank (not illustrated), so that the lead-in and lead-out takes place via bores which run in the radial direction of the connecting tubes 4. The soldering of the circular blanks takes place in the same working process as the soldering of the entire heat exchanger 1. A corresponding arrangement is also possible in all the other described exemplary embodiments.

According to the fourth exemplary embodiment illustrated in FIG. 4, individual solder points 40 of meniscus-like design are provided so as to be distributed along the entire length of the connecting tubes 4 in the region of the plates 3. Said solder points 40 can for example also be provisional cold solder points; the final connection takes place during the hot soldering process in the soldering furnace. The shape of the solder points 40 need not necessarily be round or approximately round; any desired other shapes, for example also solder points which extend in the longitudinal direction, are in fact also possible. Said solder points 40 can also be used in conjunction with one or more other connection types.

Alternatively to the individual solder points 40 according to the fourth exemplary embodiment, it is also possible to provide a continuous solder seam, for example over the entire length of the connecting tubes in the region of the plates.

In the fifth exemplary embodiment illustrated in FIG. 5, the side parts 5 are designed of elongated design and are provided with leadthroughs 50. The connecting tubes 4 are guided through the corresponding leadthrough 50, so that, as a result of the bore diameter, the connecting tubes 4 are positioned and pre-fixed in a substantially form-fitting manner. Here, precise positioning of the connecting tubes 4 is provided up to the corresponding heat exchanger end, which is not possible, or is possible only with a considerably high degree of expenditure, with the other connection types. In this case, the modular units are considerably larger than in the previously described exemplary embodiments. Said leadthroughs 50 can also be combined with any other desired connection types.

According to the sixth exemplary embodiment illustrated in FIG. 6, the outermost plate is formed with two projecting lugs 60 to which the connecting tubes 4 (merely indicated in FIG. 6) can for example be stapled, clamped or bound. Precise positioning of the connecting tubes 4 up to the corresponding heat exchanger end is also possible in this case.

The abovementioned exemplary embodiments can be combined with one another in any desired way, so that optimum positioning and pre-fixing of the modular unit is possible. The strength of the pre-fixing can be matched to the requirements. If, for example, the final assembly takes place nearby and directly thereafter, then a lower degree of securing of the modular unit is necessary than if said modular unit must be transported from one factory to another.

The illustration of the section through the solder points 40 as per FIG. 4 corresponds, in all of the described exemplary embodiments, to the finished soldered connection between the connecting tubes 4 and the outermost plate 3. Here, the solder of the solder-plated plate 3 collects, as a result of the capillary forces, in the wedge-shaped gaps between the connecting tubes 4 and the outermost plate 3. A solder plating can be provided on the connecting tubes 4 instead of or in addition to the solder-plated plate.

If solder-plated connecting tubes 4 are used, then a connecting flange can also be soldered on in the same soldering process, as a result of which the production can be further simplified and in particular the production costs can be further reduced.

The embodiment of the heat exchanger is not restricted to the above described form with U-shaped flat tubes, but rather any other desired embodiments are possible, such as for example a form with straight flat tubes which open out at their other end into a second collector.

### LIST OF REFERENCE SYMBOLS

1 Heat exchanger

2 Collector

3 Plate

4 Connecting tube

5 Side part

10 Bracket

20 Pin

30 Rim hole

40 Solder point

50 Leadthrough

60 Lug

1. A method for producing a heat exchanger, in particular for a motor vehicle, wherein a modular unit composed of the two connecting tubes, which supply or discharge the refrigerant, and at least one outer, in particular the uppermost plate or face, in which the openings pertaining to the connecting tubes are provided, of the heat exchanger, is positioned and mechanically pre-assembled, and after being placed together, is soldered in a common working process to the other parts of the heat exchanger which are to be soldered.

2. The method as claimed in claim 1, wherein during pre-assembly, the connecting tubes are positioned and pre-assembled at least on the outermost plate or face by means of one or more brackets.

3. The method as claimed in claim 2, wherein the bracket engages behind the collector.

4. The method as claimed in claim 1, wherein the connecting tubes are attached during pre-assembly by means of pins.

5. The method as claimed in claim 4, wherein the pins are inserted into openings provided in the one or more plates or in the face and into openings provided in the connecting tubes.

6. The method as claimed in claim 1, wherein the connecting tubes have openings which, during pre-assembly, are placed on rim holes in the plate.

7. The method as claimed in claim 6, wherein the rim holes remain open and serve for supplying or discharging refrigerant.

8. The method as claimed in claim 1, wherein in order to provide pre-fixing, solder points are formed between the connecting tubes and the outermost plate or face.

9. The method as claimed in claim 6, wherein the solder points for pre-fixing are spatially delimited.

10. The method as claimed in claim 1, wherein in order to provide pre-fixing, at least one side part is provided which projects beyond the connecting tubes, with one leadthrough per connecting tube being formed in the side part, with the corresponding connecting tube being inserted through said leadthrough and being pre-fixed by means thereof.

11. The method as claimed in claim 1, wherein in order to provide pre-fixing, the outermost plate or face has projecting lugs to which the connecting tubes are pre-fixed.

12. The method as claimed in claim 1, wherein before pre-assembly, at least the outermost plate or face is solder-plated in the region of contact of the connecting tubes, or the connecting tubes are solder-plated in the region of contact against the outermost plate or face.

13. A heat exchanger, in particular for a motor vehicle air conditioning system, wherein in order to produce the heat exchanger, a modular unit composed of the two connecting tubes, which supply or discharge the refrigerant, and at least the uppermost plate or face, in which the openings pertaining to the connecting tubes are provided, of the heat exchanger, are soldered in a common working process to the other parts of the heat exchanger which are to be soldered, with the connecting tubes which conduct the refrigerant to or away from the collector being fixedly soldered to one side of the heat exchanger.

14. The heat exchanger as claimed in claim 13, wherein the soldered connection runs at least over a significant region in which the connecting tubes are arranged parallel to the heat exchanger.

15. The heat exchanger as claimed in claim 13, wherein the connecting tubes are solder-plated at least in the region of the flange-side ends.

16. The heat exchanger as claimed in claim 13, wherein the outermost plate or face to which the connecting tubes are attached is solder-plated on its outside.

17. The heat exchanger as claimed in claim 13, wherein the maximum permissible operating pressure of the heat exchanger is at least 50 bar.
